(19) United States
(12) Patent Application Publication
(10) Pub. No.: US 2010/0064322 A1
(43) Pub. Date: Mar. 11, 2010

(54) APPARATUS, METHOD, AND PROGRAM FOR INFORMATION PROCESSING AND RECORDING MEDIUM FOR THE SAME

(75) Inventor: Hiroaki UNO, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/618,173

(22) Filed: Nov. 13, 2009

(30) Foreign Application Priority Data
Mar. 12, 2008 (JP) 2008-308219

(51) Int. Cl. H04N 5/445

(52) U.S. Cl. 725/50; 345/467

(57) ABSTRACT

An information processing apparatus includes: transmission means for transmitting information on an input character to an information managing apparatus along with identification information identifying a process associated with a screen on which the character is input, the information being transmitted as a request for conversion of the input character; reception means for receiving information concerning candidates of words into which the input character can be converted, transmitted by the information managing apparatus in response to the request for conversion thus transmitted; display control means for controlling display of a list of conversion candidates for the input character included in the received information; and selection accepting means for accepting the selection of a result of conversion of the input character from the displayed list of conversion candidates.

### BACKGROUND OF THE INVENTION

1. Field of the Invention

The present invention relates to an apparatus, method, and program for information processing and a recording medium for the same. More specifically, the invention relates to an apparatus, method, and program for information processing which allow a conversion process to be performed with high user-friendliness and which allow burdens laid on a user when inputting characters to be significantly reduced, and it also relates to a recording medium to be used with them.

2. Description of the Related Art

Recently, as a result of the spread of EPGs (Electronic Program Guides) and contents to be utilized over the internet, there are increasing opportunities of inputting characters to AV (Audio-Visual) apparatus such as television receivers and digital video recorders in the same way as done on information processing apparatus such as personal computers.

Unlike personal computers, apparatus such as television receivers and digital video recorders normally have no keyboard for supporting character input. A measure frequently taken under the circumstance is to use a software keyboard which is a virtual keyboard displayed on a screen of an apparatus and operated with a directional pad on a remote controller or buttons provided on the apparatus.

A software keyboard has a problem in that it is more difficult to handle in inputting characters or less operable when compared to a real keyboard provided on a personal computer or the like. In particular, the operation of inputting Japanese characters is accompanied by Kana-Kanji converting and selecting operations because Japanese includes Kanji and Katakana characters in addition to Hiragana characters, and it is very much tiresome to perform such operations by pressing a directional pad on a remote controller many times.

For example, predictive conversion is frequently used for Kana-Kanji conversion when inputting characters on a portable telephone. When predictive conversion is employed, a user is required to input only a few characters to see a list of candidates of character strings starting with the input characters, and the user can create a sentence only by repeating selection of character strings from among candidates thus listed.

For example, some proposals have been made to suggest the use of predictive conversion for inputting characters when executing an application such as a television program search (for example, JP-A-2002-351600 (Patent Document 1)). A program search is carried out by inputting limited kinds of character strings such as a performer's name and a program name. Therefore, the number of candidates for predictive conversion can be reduced to reduce burdens laid on a user when selecting character strings by creating a conversion dictionary to be used for an application for program search.

Further, proposals have been made to suggest techniques allowing character strings to be efficiently registered and edited in a dictionary using a software keyboard (for example, JP-A-2007-11974 (Patent Document 2)).

### SUMMARY OF THE INVENTION

Predictive conversion allows tiresome inputting steps to be reduced considerably as long as predictions are properly made. However, when a desired character string is not included in candidates, the character string must be manually input upto the end. For example, when the number of candidates listed is increased, there will be an increased probability of finding a desired character string among candidates. However, when the number of candidates is too great, a list becomes less user-friendly and puts an increased burden on a user who makes a selection from candidates on the list.

Even when a conversion dictionary to be used for an application for program search is created, for example, as disclosed in Patent Document 1, the problem is not thoroughly solved by such a dictionary alone because there is an enormous number of persons' names and program names to be converted. Further, since new words frequently appear as persons' names and program names, a user is required to register such new words or frequently used words to build an easy-to-use dictionary, which puts another burden on the user.

Under such circumstances, it is desirable to allow a conversion process to be performed with high user-friendliness and to allow a further reduction of burdens laid on a user when inputting characters.

According to an embodiment of the invention, there is provided an information processing apparatus including: transmission means for transmitting information on an input character to an information managing apparatus along with identification information identifying a process associated with a screen on which the character is input, the information being transmitted as a request for conversion of the input character; reception means for receiving information of candidates of words into which the input character can be converted, transmitted by the information managing apparatus in response to the request for conversion thus transmitted; display control means for controlling display of a list of conversion candidates for the input character included in the received information; and selection accepting means for accepting the selection of a result of conversion of the input character from the displayed list of conversion candidates.

The reception means may receive information of conversion candidates for the input character that the information managing apparatus obtains according to the transmitted conversion request by retrieving dictionary information identified based on the identification information from among plural types of dictionary information stored in advance.

The information processing apparatus may further include storage means for storing dictionary information to be searched for conversion candidates for the input character.

The information processing apparatus communicates with the information managing apparatus through a network. The display control means may control display of a list of conversion candidates for the input character obtained by searching the dictionary information stored in the storage means when the communication with the information managing apparatus is not properly carried out.

According to another embodiment of the invention, there is provided an information processing method including the steps of: transmitting information of an input character to an information managing apparatus along with identification information identifying a process associated with a screen on which the character is input, the information being transmitted as a request for conversion of the input character; receiving information concerning candidates of words into which the input character can be converted, transmitted by the information managing apparatus in response to the request for conversion thus transmitted; controlling display of a list of conversion candidates for the input character included in the received information; and accepting the selection of a result of conversion of the input character from the displayed list of conversion candidates.

According to still another embodiment of the invention, there is provided a program for causing a computer to function as an information processing apparatus including: transmission means for transmitting information on an input character to an information managing apparatus along with identification information identifying a process associated with a screen on which the character is input, the information being transmitted as a request for conversion of the input character; reception means for receiving information concerning candidates of words into which the input characters can be converted, transmitted by the information managing apparatus in response to the request for conversion thus transmitted; display control means for controlling display of a list of conversion candidates for the input character included in the received information; and selection accepting means for accepting the selection of a result of conversion of the input character from the displayed list of conversion candidates.

According to the above-described embodiments of the invention, information on an input character is transmitted to an information managing apparatus along with identification information identifying a process associated with a screen on which the character is input, the information being input as a request for conversion of the input character. The information processing apparatus receives information concerning candidates of words into which the input characters can be converted, transmitted by the information managing apparatus in response to the conversion request thus transmitted. The display of a list of conversion candidates for the input character included in the information thus received is controlled, and the selection of a result of conversion of the input character from the displayed list of conversion candidates is accepted.

According to yet another embodiment of the invention, there is provided an information processing apparatus including: reception means for receiving a request for conversion transmitted from an electronic apparatus connected to the information processing apparatus, the conversion request including information of a character input at the electronic apparatus and identification information identifying a process associated with a screen on which the character is input; identifying means for identifying predetermined dictionary information among plural types of dictionary information stored in advance based on the identification information included in the received conversion request; search means for searching for candidates of words into which the character included in the conversion request can be converted using the identified dictionary information; and transmission means for transmitting information of the conversion candidates obtained as a result of the search to the electronic apparatus.

The conversion candidates retrieved using the dictionary information may be identified based on information on choices made by a user of the electronic apparatus from among conversion candidates included in information transmitted in the past.

According to further another embodiment of the invention, there is provided an information processing method executed at an information processing apparatus, including the steps of: receiving a request for conversion transmitted from an electronic apparatus connected to the information processing apparatus, the conversion request including information of a character input at the electronic apparatus and identification information identifying a process associated with a screen on which the character is input; identifying predetermined dictionary information among plural types of dictionary information stored in advance based on the identification information included in the received conversion request; searching for candidates of words into which the character included in the conversion request can be converted using the identified dictionary information; and transmitting information of the conversion candidates obtained as a result of the search to the electronic apparatus.

According to a furthermore embodiment of the invention, there is provided a program causing a computer to function as an information processing apparatus including: reception means for receiving a request for conversion transmitted from an electronic apparatus connected to the information processing apparatus, the conversion request including information of a character input at the electronic apparatus and identification information identifying a process associated with a screen on which the character is input; identifying means for identifying predetermined dictionary information among plural types of dictionary information stored in advance based on the identification information included in the received conversion request; search means for searching for candidates of words into which the character included in the conversion request can be converted using the identified dictionary information; and transmission means for transmitting information on the conversion candidates obtained as a result of the search to the electronic apparatus.

According to the embodiments of the invention, the information processing apparatus receives a request for conversion transmitted from an electronic apparatus connected to the information processing apparatus. The conversion request includes information of a character input at the electronic apparatus and identification information identifying a process associated with a screen on which the character is input. Predetermined dictionary information is identified among plural types of dictionary information stored in advance based on the identification information included in the conversion request thus received. A search is performed for candidates of words into which the character included in the conversion request can be converted using the dictionary information thus identified. Information of the conversion candidates obtained as a result of the search is transmitted to the electronic apparatus.

According to the embodiments of the invention, a conversion process can be executed with high user-friendliness, and burdens placed on a user when inputting characters can be reduced.

### BRIEF DESCRIPTION OF THE DRAWINGS

FIG. 1 is a block diagram showing an exemplary configuration of a character conversion system according to an embodiment of the invention;

FIG. 2 is an illustration for explaining a conversion process performed by the character conversion system shown in FIG. 1;

FIG. 3 is an illustration showing an example of a list of conversion candidates displayed on a display;

FIG. 4 is a block diagram showing an exemplary configuration of the client shown in FIG. 1;

FIG. 5 is a block diagram showing an exemplary functional configuration of software executed by the CPU shown in FIG. 4;

FIG. 6 is a block diagram showing an exemplary configuration of the server shown in FIG. 1;

FIG. 7 is a block diagram showing an exemplary functional configuration of software executed by the CPU shown in FIG. 6;

FIG. 8 is a flow chart for explaining a conversion process; and

FIG. 9 is a flow chart for explaining processes executed at the server.

### DESCRIPTION OF PREFERRED EMBODIMENTS

An embodiment of the invention will now be described with reference to the drawings.

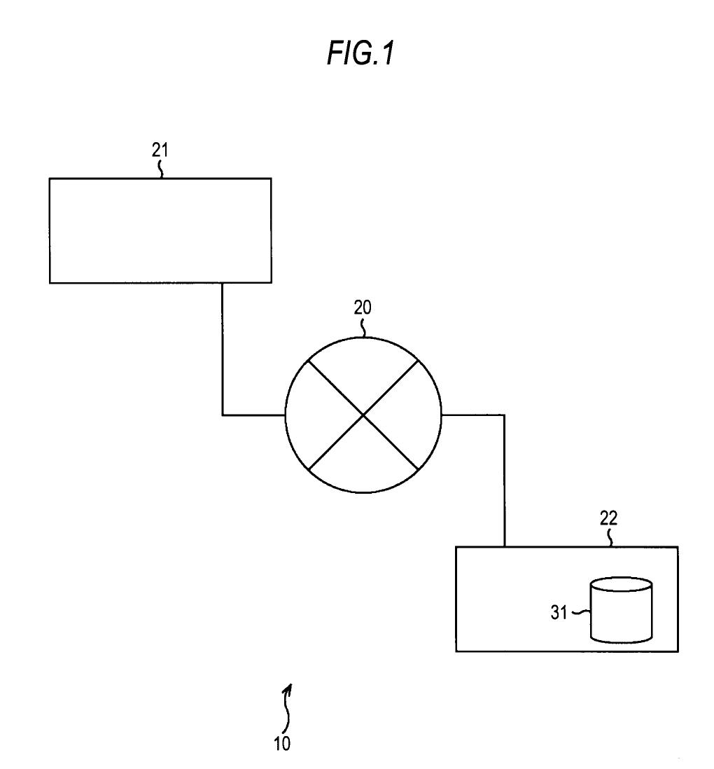

FIG. 1 is a block diagram showing an exemplary configuration of a character conversion system according to an embodiment of the invention. Referring to FIG. 1, a character conversion system 10 is configured by connecting a client 21 and a server 22 over a network 20.

For example, the client 21 shown in FIG. 1 is a television receiver. The client 21, which is a television receiver, accepts an instruction from a user through, for example, a remote controller.

The remote controller has a power switch for turning supply of power to the television receiver on and off, a channel button for selecting a channel, and a volume adjust switch for adjusting the volume of sounds output from a speaker (not shown). The remote controller also includes a cursor control switch for controlling the position of a cursor on a GUI (Graphic User Interface) displayed on the display of the television receiver. For example, the cursor control switch may be a directional pad.

In a memory of the client 21 which is a television receiver, image data and the like are stored to allow an image of a keyboard to be displayed for implementing functions of a keyboard on a software basis (hereinafter referred to as “software keyboard”). The software keyboard is displayed on the display based on the image data.

When the software keyboard is displayed on the display of the television receiver, a user can select keys on the software keyboard by operating the cursor control switch on the remote controller to input desired characters.

For example, the server 22 shown in FIG. 1 is a computer having a general-purpose operating system installed therein, and the server includes a database 31 that is a collection of data accumulated in a recording medium provided in the computer itself. For example, data stored in the database 31 includes dictionary information which allows a content name, a person's name, a place name, or a word to be searched in association with information supplied in the form of characters.

For example, a conversion process can be performed by an application program executed by a CPU of the server 22 using the dictionary information in the database 31. For example, when Kana characters are input, the server 22 generates candidates of Kanjis into which the Kanas can be converted.

In the server 22, predictive conversion is performed, for example, in the same way as that performed on characters input to a portable telephone. When predictive conversion is employed, a user is required to input only a few characters to see a list of candidates of character strings starting with the input characters, and the user can create a sentence only by repeating selection of character strings from among candidates thus listed.

When characters are input from the client 21 to the character conversion system 10 using the software keyboard, information on the input characters is transmitted to the server 22 over the network 20, and the server 22 performs a conversion process on the same. Information on conversion candidates generated by the server 22 is transmitted to the client 21 over the network 20, and the conversion candidates are displayed on the display of the client 21. The user can finalize the input by selecting a desired candidate from among the conversion candidates displayed on the display of the client 21.

As thus described, the character conversion system 10 converts characters input from the client 21 using functions of the server 22, and character strings and the like obtained by the conversion can be used as inputs for enabling execution of various processes.

For example, characters input at the client 21 are converted using functions of the server 22, and a user can retrieve a program by searching an EPG (Electronic Program Guide) using a character string obtained by the conversion. Further, the user can convert characters input at the client 21 using functions of the server 22, and sentences formed by character strings obtained by the conversion can be transmitted as an electronic mail.

The dictionary information stored in the database 31 of the server 22 includes plural types of dictionary information. For example, conversion candidates generated based on one type of dictionary information may be different from conversion candidates generated based on another type of dictionary information even if the same characters are input.

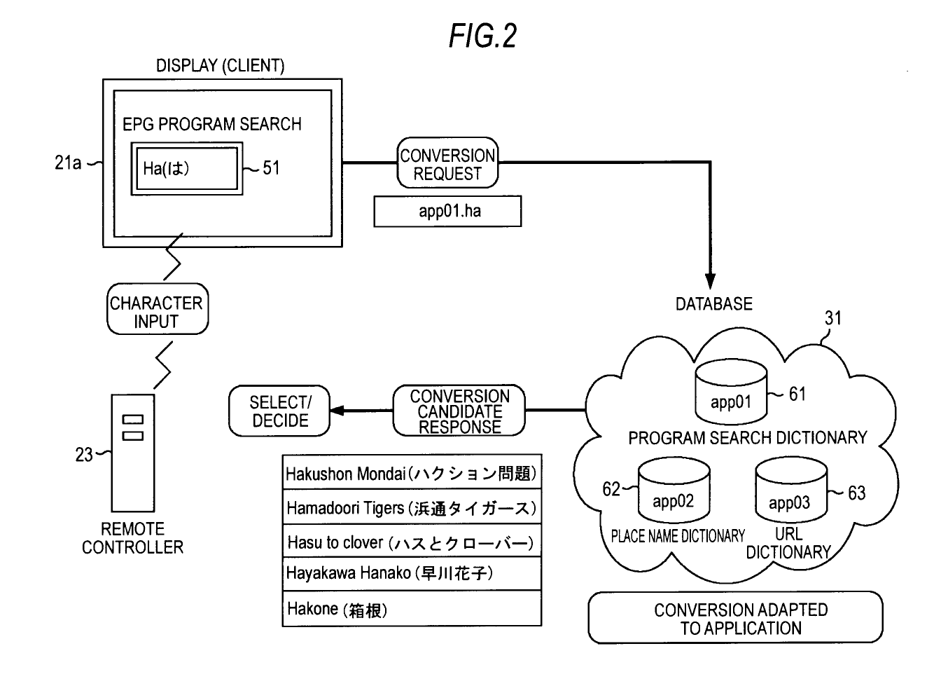

The conversion process performed by the character conversion system 10 will be described further with reference to FIG. 2. The following description will address an example in which a program search is carried out at the client 21 that is a television receiver.

As shown in FIG. 2, a screen for a program search is displayed on a display 21a of the client 21. The screen shows a description “EPG program search”, and a program associated with a character string input in a box 51 is retrieved based on an EPG which is received in advance,

A user operates a remote controller 23 to input characters in the box 51 displayed on the screen having a description “EPG program search”. At this time, for example, a software keyboard is displayed to enable characters to be input in association with operations on the remote controller 23. In the example shown in FIG. 2, characters “ha” are input.

The user instructs the execution of a process of converting the characters input in the box 51, for example, by pressing a predetermined switch on the remote controller 23. Thus, information on the characters currently input in the box 51 is transmitted to the server 22 along with information concerning the screen currently displayed on the display 21a.

The information on the characters currently input in the box 51 and the information concerning the screen currently displayed on the display 21a are pieces of information required for the server 22 to perform a conversion process utilizing dictionary information. In this example, information “app01, ha” is transmitted from the client 21 to the server 22 as a request for conversion.

The information “app01” transmitted at this time is information concerning the screen displayed on the display 21a. In this case, the information is an identifier identifying an application program which will execute the “EPG program search” process. That is, an application program identified by the identifier “app01” is activated at the client 21 to execute a program search process. Thus, a screen for “EPG program search” is displayed on the display 21a.

The characters “ha” transmitted at this time represent the information on the character currently input in the box 51. In this case, the information “ha” is a Roman letter input representing a Hiragana character pronounced as “ha”.

The information transmitted from the client 21 as a request for conversion is received by the server 22 at which a conversion process is performed utilizing dictionary information. At this time, the server 22 identifies dictionary information to be used for the conversion process based on the information concerning the screen displayed on the displayed 21a (hereinafter referred to as “application identifier” as occasion demands) included in the information transmitted from the client 21 as a request for conversion. In this case, since the application identifier “app01” is received, dictionary information 61, which is associated with the application identifier “app01” as dictionary information for program search, is identified as dictionary information to be used for the conversion process.

The server 22 acquires candidates for conversion associated with the character information “ha” currently input in the box 51 using the dictionary information 61 thus identified. At this time, a plurality of candidates starting with characters “ha” such as content names, persons' names, place names, and words are retrieved. Each of conversion candidates retrieved from the dictionary information stored in the server 22 is accompanied by priority information assigned in advance. The server 22 outputs the content names, persons' names, place names, and words starting with characters “ha” in the order of priority.

In the example shown in FIG. 2, a performer's name “Hakusyon Mondai” and a sport team's name “Hamadoori Taigaasu” are retrieved and acquired as examples of conversion candidates associated with characters “ha”. A content name “Hasu to kuroobaa” is also retrieved and acquired as another exemplary conversion candidate associated with characters “ha”. A person's name “Hayakawa Hanako” is also retrieved and acquired as another exemplary conversion candidate associated with characters “ha”. A place name “Hakone” is also retrieved and acquired as still another exemplary conversion candidate associated with characters “ha”. The server 22 transmits information on the candidates for conversion thus acquired to the client 21. Thus, candidates for conversion are returned.

A preset number of conversion candidates associated with predetermined characters transmitted as a request for conversion are acquired, for example, in the order of priority.

A description has been made above on an example in which dictionary information 61 associated with an application program “EPG program search” is used. As described above, the dictionary information stored in the database 31 includes plural types of dictionary information.

The dictionary information stored in the database 31 is optimized in association with each application identifier unlike common dictionaries used for Kana-Kanji conversion. For example, the dictionary information 61 associated with the application identifier for “EPG program search” includes conversion candidates in categories such as “hot springs”, “historical plays”, and “sports”, which are registered in advance, in addition to content (program) names and persons' names. The dictionary information 61 is configured such that a conversion candidate is given higher priority, the higher the possibility of the character string constituting the candidate being used for a program search.

For example, when an application program “map display” (application identifier “app02”) is executed at the client 21, dictionary information 62 stored in the database 31 is used. Conversion candidates such as place names, station names, and landmark names are registered in advance as the dictionary information 62. The dictionary information 62 is created such that character strings of words and phrases inappropriate as inputs for the application “map display”, e.g., “kaerimasita” (which means “I'm home.”) and “yorosiku onegaisimasu” (which means “I'm glad to make your acquaintance”) will not be included in the conversion candidates. Alternatively, the dictionary information 62 may be created such that character strings of words and phrases inappropriate as inputs for the application “map display” will be given as conversion candidates having low priority.

Similarly, when an application program (application identifier “app03”) for searching for a predetermined URL (uniform resource locator) is executed at the client 21, dictionary information 63 stored in the database 31 is used.

Thus, it is possible to exclude unnecessary words or phases from conversion candidates for each application program executed by the client 21.

The dictionary information stored in the database 31 is edited and managed, for example, by the vendor of the client 21. For example, the vendor of the client 21 makes additions and deletions to and from conversion candidates registered in the dictionary information 61 to 63 and sets priority information for the conversion candidates.

For example, when the broadcast of a new program “Karee no Supaisu” (which means “curry spice”) is started, a character string “Karee no Supaisu” is added to conversion candidates associated with characters “ka”. For example, a high degree of priory is set for a conversion candidate “Orinpikku” (which means “Olympic games”) associated with the character “o” in the dictionary information 61 during the period of Olympic games. When the Olympic games are over, high degrees of priority are set for conversion candidates such as “onsen” (which means “hot springs”) and “ongaku (which means “music”) associated with the character “o”.

Alternatively, the server may analyze frequencies of inputs from a great number of users to set high degrees of priority for conversion candidates which are selected to be input at high frequencies. Specifically, information on a conversion candidate which has been finally selected by the user from among a plurality of conversion candidates may be fed back to the server 22 from the client 21 to allow the server 22 to automatically learn information on the priority of each piece of dictionary information from such feedback.

Such an approach makes it possible to prevent an increase in the load of the operation of selecting a conversion candidate which can otherwise occur, for example, when a list of conversion candidates includes many unnecessary candidates. Further, even in an instance in which new words such as content names and persons' names frequently appear, burdens including the operation of newly registering such words will not be laid on a user.

As a result, a conversion process can be performed with high user-friendliness, and burdens laid on a user when inputting characters can be reduced further.

The client 21 acquires information on conversion candidates transmitted from the server 22 and displays the conversion candidates on the display. The user operates the remote controller 23 to select a desired conversion candidate from among a plurality of conversion candidates, thereby deciding characters to be input in the box 51.

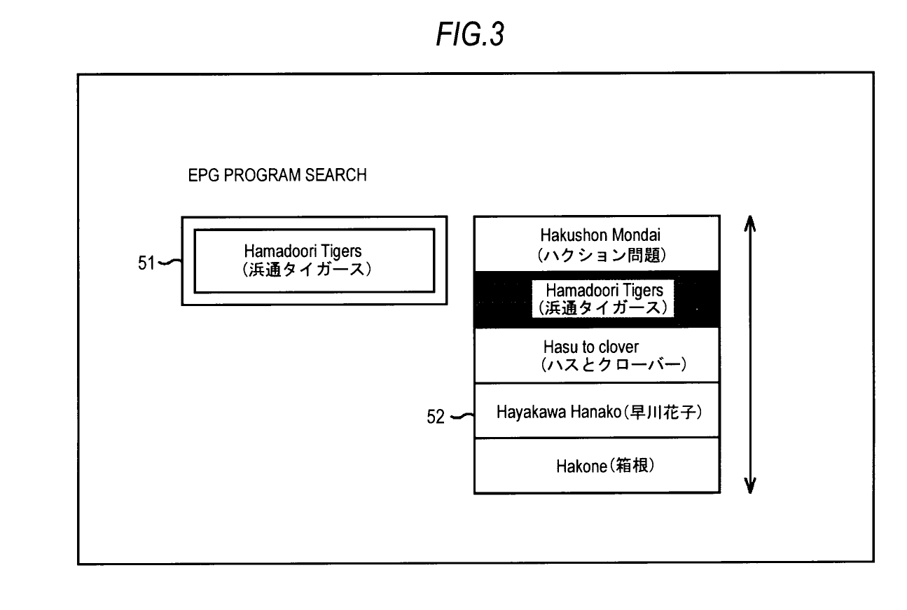

FIG. 3 shows an example of a screen shown on the display of the client 21, the screen listing conversion candidates transmitted from the server 22. In this example, an area 52 for displaying a list of conversion candidates is provided on the right side of the box 51. In FIG. 3, the hatched part of the area 52 is associated with the cursor position. The user can operate the remote controller 23 to move the cursor position to any of the conversion candidates displayed in the area 52. Thus, a conversion candidate can be selected.

For example, the user may operate a cursor control switch on the remote controller 23 to sequentially move the cursor position in the directions indicated by the arrow shown on the right of the area 52 in the figure.

In this example, conversion candidates associated with characters “ha”, i.e., “Hakusyon Mondai”, “Hamadoori Taigaasu”, “Hasu to kuroobaa”, “Hayakawa Hanako”, and “Hakone” are displayed in the area 52, and the cursor position is set at “Hamadoori Taigaasu”. When the user depresses a predetermined switch or the like on the remote controller 23 with the screen in the state shown in FIG. 3, “Hamadoori Taigaasu” is decided as characters to be finally input in the box 51.

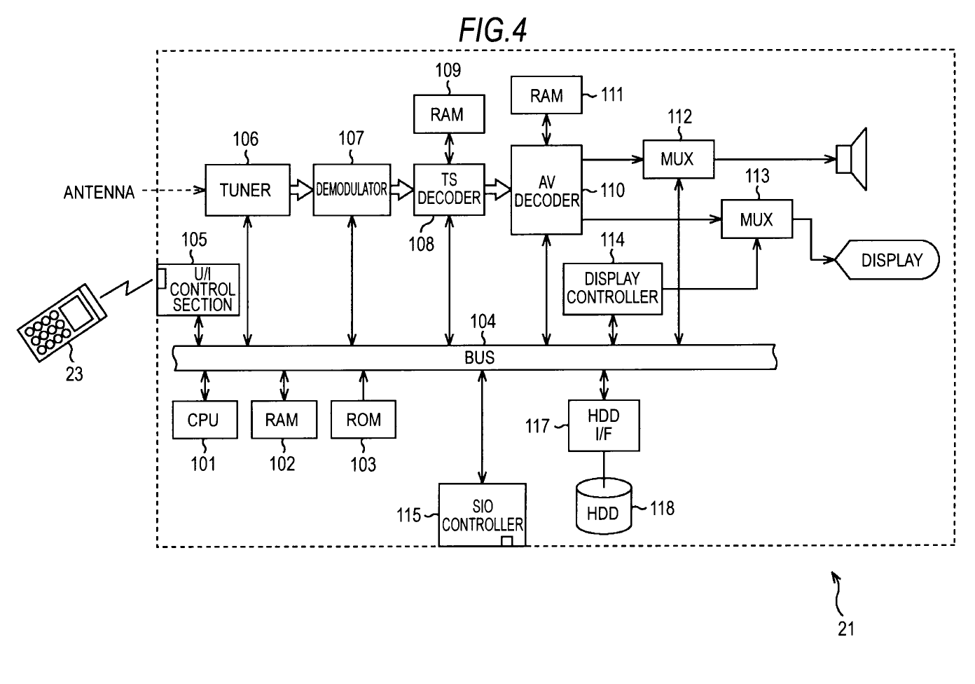

FIG. 4 is a block diagram of an exemplary configuration of the client 21. Referring to FIG. 4, a CPU (Central Processing Unit) 101 executes programs stored in a ROM (Read Only Memory) 103 and programs loaded from an HDD 118 to a RAM (Random Access Memory) 102 through an HDD interface 117 and a bus 104. The CPU controls operations of various parts of the client according to instructions from the user received at a U/I control section 105 (commands from the remote controller 23).

A tuner 106 receives broadcast signals from an antenna, which is not shown, under control exercised by the CPU 101, and the tuner outputs the received signals to a demodulator 107.

The demodulator 107 demodulates the received signals supplied from the tuner 106 to output transport streams broadcast over a predetermined channel to a TS decoder 108.

The TS decoder 108 extracts a predetermined stream from the transport streams supplied from the demodulator 107 under control exercised by the CPU 101, using a RAM 109. The decoder outputs the packets forming the extracted stream onto the bus 104 or to an AV decoder 110. The packets (data of a program) supplied onto the bus 104 are supplied to an HDD 118 through an HDD interface 117 and recorded in the HDD as occasion demands.

Data of an EPG obtained by the TS decoder 108 is also supplied to the HDD 118 and stored therein as occasion demands. The EPG is transmitted by, for example, superimposing it on a broadcast wave.

The AV decoder 110 decodes video data (video packets) and audio data (audio packets) supplied from the TS decoder 108 using a RAM 111 and outputs audio signals and video signals obtained by decoding the data to an MUX 112 and an MUX 113, respectively.

The MUX 112 causes a speaker of the television receiver 12 to output sounds associated with the audio signals supplied from the AV decoder 110.

The MUX 113 causes the display to display predetermined images (screens) based on the video signals supplied from the AV decoder 110 and video signals (OSD (On-Screen Display) signals) supplied from a display controller 114.

The display controller 114 generates video signals for displaying screens associated with display data under control exercised by the CPU 101 and outputs the video signals thus generated to the MUX 113.

For example, a high-speed modem is connected to an SIO (serial I/O) controller 115, and the controller controls communication with the network 20 through the high-speed modem.

Although the block diagram of FIG. 4 has been described on an assumption that the client 21 is a television receiver, the client 21 is not necessarily a television receiver. For example, the client 21 may be an HDD decoder, a personal computer, or a portable telephone.

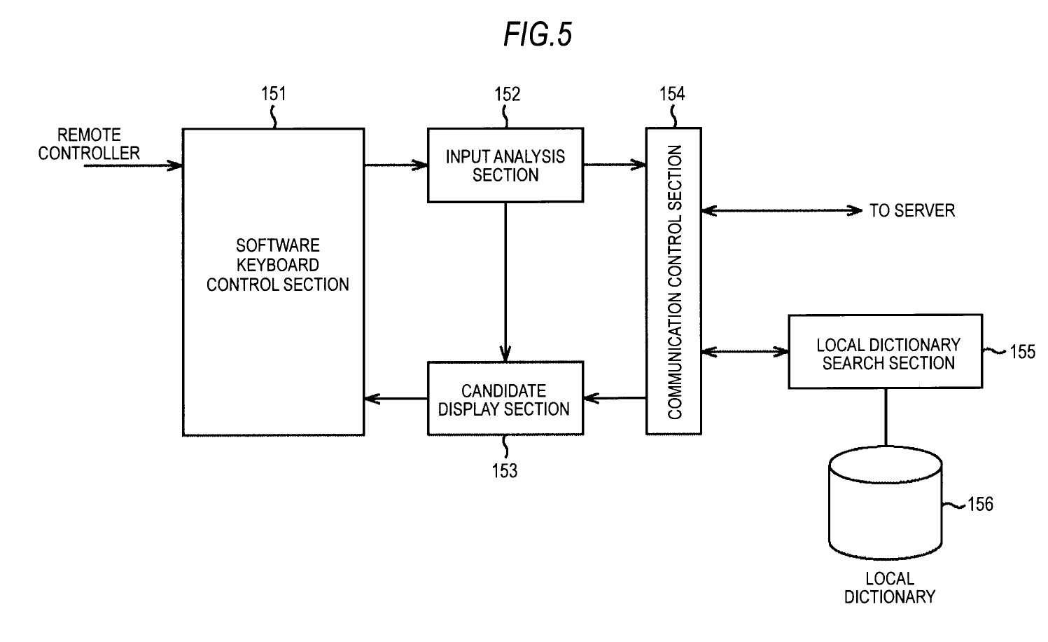

FIG. 5 is a block diagram showing an exemplary functional configuration of software such as programs executed by the CPU 101 shown in FIG. 4.

A software keyboard control section 151 causes the displays to display a software keyboard and exercises control over input of characters and the like using the software keyboard in association with signals received from the remote controller 23. The software keyboard control section 151 identifies the application identifier associated with the screen which is currently displayed on the display and supplies the identifier to an input analysis section 152.

The input analysis section 152 analyses the content of an input from the software keyboard which is supplied under control exercised by the software keyboard control section 151. The input analysis section 152 performs analysis to determine whether the input from the software keyboard is input of characters to be converted or input of a command for selecting and deciding on a candidate. When the input from the software keyboard is input of characters to be converted, information on the characters is supplied to a communication control section 154 along with the application identifier. When the input from the software keyboard is input of a command for selecting and deciding on a candidate, information on the command is supplied to a candidate display section 153.

The candidate display section 153 causes the display to display a list of conversion candidates obtained through the communication control section 154 and selects and decides on a predetermined conversion candidate among the candidates on the list based on the information on the command supplied from the input analysis section 152.

The communication control section 154 controls a communication process between the client and the server 22 through the network 20. The communication control section 154 identifies the application identifier associated with the screen which is currently displayed on the display. The identifier is transmitted along with the information of the characters which are currently input in the box 51 to the server 22, as a conversion request. The communication control section 154 receives a conversion candidate response transmitted from the server 22 and supplies it to the candidate display section 153.

The communication control section 154 also supplies the conversion request to a local dictionary search section 155 as occasion demands.

The local dictionary search section 155 controls searches into a local dictionary that is dictionary information stored in the HDD 118 of the client 21. For example, the local dictionary may be a common Kana-Kanji conversion dictionary or a dictionary uniquely edited by the user. Alternatively, the local dictionary may be similar to the dictionary information 61 to 63 of the server 22.

When the client cannot properly communicate with the server 22, the communication control section 154 may supply the conversion request to the local dictionary search section 155. For example, when a timeout is detected during communication with the server 22 carried out according to a predetermined protocol, the communication control section 154 supplies the conversion request to the local dictionary search section 155.

The communication control section 154 may supply the conversion request to the local dictionary search section 155 when a predetermined application identifier is detected. For example, when an application identifier associated with the creation of an electronic mail is detected, the conversion request may be supplied to the local dictionary search section 155.

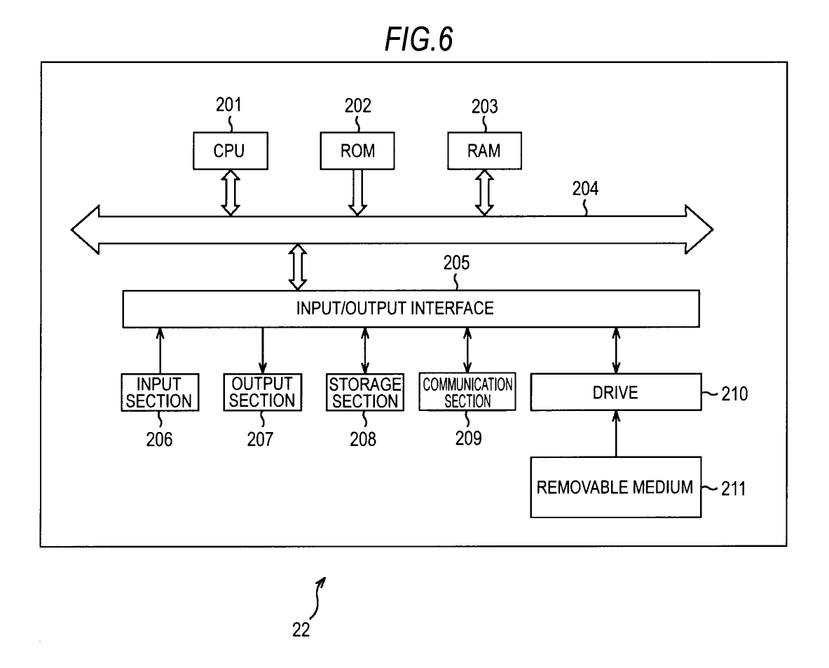

FIG. 6 is a block diagram showing an exemplary configuration of the server 22. Referring to FIG. 6, a CPU (Central Processing Unit) 201 executes various processes according to programs stored in a ROM (Read Only Memory) 202 or programs loaded from a storage section 208 to a RAM (Random Access Memory) 203. Data required for the CPU 201 to execute the various processes are also stored in the RAM 203 as occasion demands.

The CPU 201, the ROM 202, and the RAM 203 are connected to each other through a bus 204. An input/output interface 205 is also connected to the bus 204.

An input section 206 including a keyboard and a mouse, an output section 207 including a display such as a CRT (Cathode Ray Tube) or an LCD (Liquid Crystal Display) and a speaker, a storage section 208 including a hard disc, and a communication section 209 including a modem and a network interface card such as a LAN card are connected to the input/output interface 205. The communication section 209 performs communication processes through networks including the internet.

A drive 210 is also connected to the input/output interface 205 as occasion demands. A removable medium 211 such as a magnetic disc, an optical disc, a magneto-optical disc, or a semiconductor memory is inserted in the drive, and computer programs read out from the medium is installed in the storage section 208 as occasion demands.

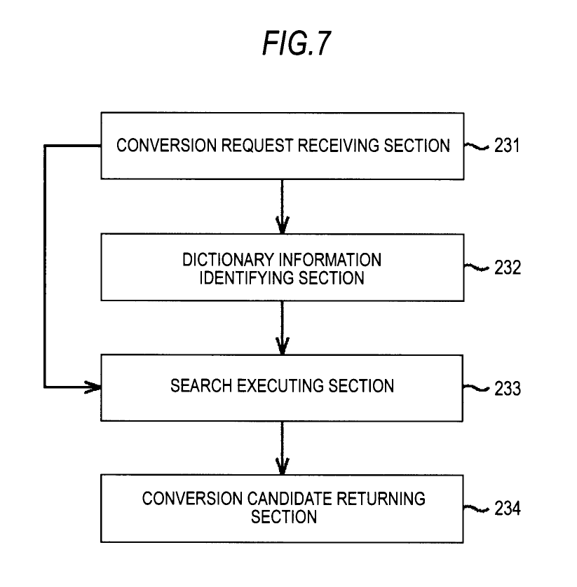

FIG. 7 is a block diagram showing an exemplary functional configuration of software such as programs executed by the CPU 201 shown in FIG. 6.

Referring to FIG. 7, a conversion request receiving section 231 receives a conversion request transmitted from the client 21, supplies information on the characters currently input in the box 51 to a search executing section 233, and supplies the relevant application identifier to a dictionary information identifying section 232. For example, in the example shown in FIG. 2, the application identifier “app01” is supplied to the dictionary information identifying section 232, and “ha” is supplied to the search executing section 233 as information on the characters currently input in the box 51.

The dictionary information identifying section 232 identifies dictionary information to be used for retrieving conversion candidates based on the application identifier supplied from the conversion request receiving section 231. For example, in the example shown in FIG. 2, the dictionary information 61 associated with the application identifier “app01” is identified as being the dictionary information to be used.

The search executing section 233 retrieves conversion candidates associated with the information on the characters currently input in the box 51 supplied from the conversion request receiving section 231 based on the dictionary information identified by the dictionary information identifying section 232. Thus, a predetermined number of conversion candidates are obtained in the order of priority.

The conversion candidate returning section 234 generates information on a conversion candidate response for transmitting the conversion candidates obtained by the search executed by the search executing section 233 to the client 21. The information on a conversion candidate response is transmitted to the client 21 through the network 20. For example, in the example shown in FIG. 2, information on conversion candidates including “Hakusyon Mondai”, “Hamadoori Taigaasu”, “Hasu to kuroobaa”, “Hayakawa Hanako”, and “Hakone”, which are conversion candidates associated with characters “ha”, is transmitted to the client 21.

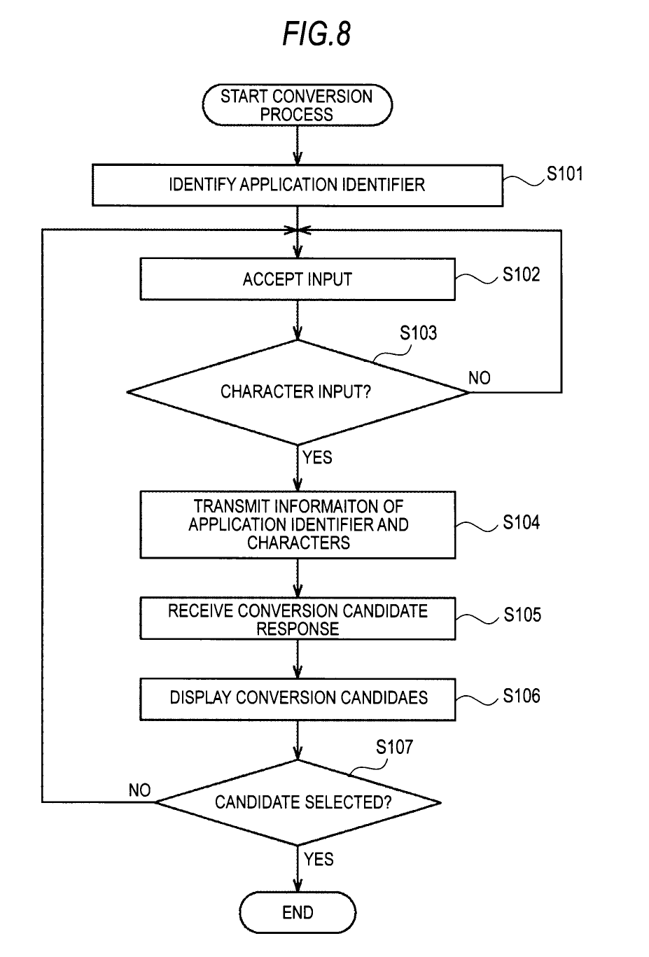

The conversion process carried out at the client 21 will now be described with reference to the flow chart in FIG. 8.

At step S101, the software keyboard control section 151 causes the display to display a software keyboard and identifies the application identifier which is associated with the screen currently displayed on the display.

At step S102, the software keyboard control section 151 exercises control over input of characters using the software keyboard in association with signals received from the remote controller 23 to accept input of characters.

At step S103, the input analysis section 152 analyzes the content of the input from the software keyboard accepted at the process of step S102 to determine whether the input from the software keyboard is input of characters to be converted. When it is determined at step S103 that no character has been input yet, the process returns to step S102. When it is determined at step S103 that characters have been input, the process proceeds to step S104.

At step S104, the communication control section 154 transmits the application identifier identified at the process of step S101 and the information on the characters accepted at the process of step S102 to the server 22 as a request for conversion. Thus, the request for conversion is received at the server 22 through the network 20. As described above with reference to FIG. 2, information on a conversion candidate response is transmitted from the server 22 to the client 21 through the network 20.

At step S105, the communication control section 154 receives the conversion candidate response transmitted from the server 22.

At step S106, the candidate displaying section 153 causes the display to display a list of conversion candidates included in the information on the conversion candidate response obtained via the communication control section 154.

At step S107, the candidate displaying section 153 determines whether a predetermined conversion candidate has been selected from the list of conversion candidates based on information such as a command supplied from the input analysis section 152. When it is determined at step S107 that no conversion candidate has been selected, the process returns to step S102. When it is determined at step S107 that a conversion candidate has been selected, the process is terminated.

The conversion process is performed as thus described.

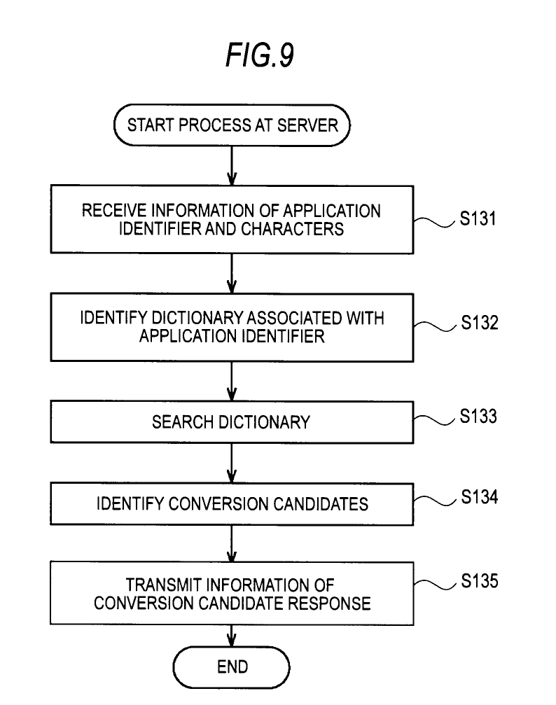

A description will now be made with reference to the flow chart in FIG. 9 on the process executed by the server 22 in association with the conversion process described above with reference to the flow chart in FIG. 8.

At step S131, the conversion request receiving section 231 receives the conversion request transmitted from the client 21. Thus, the information on the characters currently input in the box 51 included in the conversion request is supplied to the search executing section 233, and the application identifier included in the conversion request is supplied to the dictionary information identifying section 232.

At step S132, the dictionary information identifying section 232 identifies dictionary information to be searched for conversion candidates among plural types of dictionary information based on the application identifier supplied from the conversion request receiving section 231. For example, in the example shown in FIG. 2, the dictionary information 61 is identified as information associated with the application identifier “app01” among the dictionary information 61 to 63.

At step S133, based on the dictionary information identified at the process of step S132, the search executing section 233 retrieves conversion candidates associated with the information on the characters currently input in the box 51 included in the conversion request received at the process of step S131.

At step S134, the search executing section 233 identifies conversion candidates based on the result of the process at step S133. Thus, a predetermined number of conversion candidates associated with the information on the characters included in the conversion request received at the process of step S131 are identified in the order of priority. For example, in the example shown in FIG. 2, five conversion candidates “Hakusyon Mondai”, “Hamadoori Taigaasu”, “Hasu to kuroobaa”, “Hayakawa Hanako”, and “Hakone” are identified as conversion candidates associated with characters “ha”.

At step S135, the conversion candidate returning section 234 generates information on a conversion candidate response for transmitting the conversion candidates identified at the process of step S134. The information on the conversion candidate response is transmitted from the server 22 to the client 21 through the network 20.

The process at the server 22 is executed as thus described.

According to the embodiment of the invention, a list of conversion candidates displayed in response to an input from a user is limited to candidates which are appropriate for the application program of the screen displayed on the display. As a result, burdens laid on the user when selecting a candidate can be reduced.

According to the embodiment of the invention, the dictionary information is edited and managed at the server 22 in a centralized manner by the vendor of the client 21. Therefore, the user is not bothered by the operation of editing a dictionary. Further, since the dictionary information can be always edited at the server 22, a word which has newly appeared can be accommodated any time. The order of listing of conversion candidates can be controlled by making a change in priority information. For example, user-friendliness can be improved by setting high priority for conversion candidates or words which are frequently used by a great number of users or which are in fashion.

Further, since the dictionary information is stored at the server 22, the same dictionary information can be shared by a plurality of clients, and resources in client apparatus can therefore be efficiently utilized.

Although it has been described above that the dictionary information at the server 22 is generated in association with each application identifier, the information may alternatively be generated in association with each user. In this case, for example, a user ID may be included in a request for conversion, and conversion candidates may be retrieved using dictionary information associated with the user ID.

When the dictionary information at the server 22 is generated in association with each user, for example, conversion candidates appropriate for each user can be displayed on the screen even from dictionary information used for the same “EPG program search” process.

Alternatively, a user may be given an option on whether to use the dictionary information at the server 22 or not. In this case, for example, the user may switch on/off a menu on a screen displayed on the display of the client 21 to determine whether to use the server dictionary or not. For example, the use of the server dictionary information may be set off when the user wishes to input all character strings by him- or herself or when the user prefers to use local dictionary 156 at the client 21.

Although the above description has been made on an assumption that characters and the like are input using a software keyboard, it is not essential to use a software keyboard. For example, a speech recognition process program may be used instead of the software keyboard to allow characters to be input in accordance with the voice of a user.

Obviously, a common hardware keyboard may be used instead of the software keyboard to input characters.

Further, although the above description has addressed a case in which the client 21 and the server 22 are connected through the network 20, they may obviously be connected to each other using other methods. For example, the client 21 and the server 22 may be connected through an interface such as an HDMI (High-Definition Multimedia Interface) or a USB (Universal Serial Bus).

The above-described series of processes may be executed using either hardware or software. When the series of process is executed using software, programs constituting the software are installed from a program recording medium to a computer incorporated in dedicated hardware or a general-purpose personal computer in which various programs can be installed to execute various functions.

Program recording media usable for storing programs to be installed in a computer and to be enabled for execution by the computer are magnetic discs (including flexible discs), optical discs (including CD-ROMs (Compact Disc-Read Only Memories), DVDs (Digital Versatile Discs), and magneto-optical discs), removable media which are package media including a semiconductor memory, and ROMs and hard discs in which programs can be temporarily or permanently stored. A program is stored in such a program recording medium through an interface such as a router or modem provided as occasion demands using a wired or wireless communication medium such as a local area network, internet or digital satellite broadcast.

Steps for describing a program according to this specification include steps for describing not only processes which are executed in a time-sequential manner in the order of description but also processes which are executed in parallel or independently of each other rather than being executed in a time-sequential manner.

The present application contains subject matter related to that disclosed in Japanese Priority Patent Application JP 2008-308219 filed in the Japan Patent Office on Dec. 3, 2008, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
transmission means for transmitting information on an input character to an information managing apparatus along with identification information identifying a process associated with a screen on which the character is input, the information being transmitted as a request for conversion of the input character;
reception means for receiving information concerning candidates of words into which the input character can be converted, transmitted by the information managing apparatus in response to the request for conversion thus transmitted;
display control means for controlling display of a list of conversion candidates for the input character included in the received information; and
selection accepting means for accepting the selection of a result of conversion of the input character from the displayed list of conversion candidates.

2. An information processing apparatus according to claim 1, wherein the reception means receives information on conversion candidates for the input character that the information managing apparatus obtains according to the transmitted conversion request by retrieving dictionary information identified based on the identification information from among plural types of dictionary information stored in advance.

3. An information processing apparatus according to claim 1, further comprising storage means for storing dictionary information to be searched for conversion candidates for the input character.

4. An information processing apparatus according to claim 3, which communicates with the information managing apparatus through a network and wherein the display control means controls display of a list of conversion candidates for the input character obtained by searching the dictionary information stored in the storage means when the communication with the information managing apparatus is not properly carried out.

5. An information processing method comprising the steps of:
transmitting information on an input character to an information managing apparatus along with identification information identifying a process associated with a screen on which the character is input, the information being transmitted as a request for conversion of the input character;
receiving information concerning candidates of words into which the input character can be converted, transmitted by the information managing apparatus in response to the request for conversion thus transmitted;
controlling display of a list of conversion candidates for the input character included in the received information; and
accepting the selection of a result of conversion of the input character from the displayed list of conversion candidates.

6. A program for causing a computer to function as an information processing apparatus comprising:
transmission means for transmitting information on an input character to an information managing apparatus along with identification information identifying a process associated with a screen on which the character is input, the information being transmitted as a request for conversion of the input character;
reception means for receiving information concerning candidates of words into which the input character can be converted, transmitted by the information managing apparatus in response to the request for conversion thus transmitted;
display control means for controlling display of a list of conversion candidates for the input character included in the received information; and
selection accepting means for accepting the selection of a result of conversion of the input character from the displayed list of conversion candidates.

7. An information processing apparatus comprising:
reception means for receiving a request for conversion transmitted from an electronic apparatus connected to the information processing apparatus, the conversion request including information on a character input at the electronic apparatus and identification information identifying a process associated with a screen on which the character is input;
identifying means for identifying predetermined dictionary information among plural types of dictionary information stored in advance based on the identification information included in the received conversion request;
search means for searching for candidates of words into which the character included in the conversion request can be converted using the identified dictionary information; and
transmission means for transmitting information on the conversion candidates obtained as a result of the search to the electronic apparatus.

8. An information processing apparatus according to claim 7, wherein the conversion candidates retrieved using the dictionary information are identified based on information on choices made by a user of the electronic apparatus from among conversion candidates included in information transmitted in the past.

9. An information processing method executed at an information processing apparatus, comprising the steps of:
receiving a request for conversion transmitted from an electronic apparatus connected to the information processing apparatus, the conversion request including information on a character input at the electronic apparatus and identification information identifying a process associated with a screen on which the character is input;
identifying predetermined dictionary information among plural types of dictionary information stored in advance based on the identification information included in the received conversion request;
searching for candidates of words into which the character included in the conversion request can be converted using the identified dictionary information; and
transmitting information on the conversion candidates obtained as a result of the search to the electronic apparatus.

10. A program causing a computer to function as an information processing apparatus comprising:
reception means for receiving a request for conversion transmitted from an electronic apparatus connected to the information processing apparatus, the conversion request including information on a character input at the electronic apparatus and identification information identifying a process associated with a screen on which the character is input;
identifying means for identifying predetermined dictionary information among plural types of dictionary information stored in advance based on the identification information included in the received conversion request;
search means for searching for candidates of words into which the character included in the conversion request can be converted using the identified dictionary information; and
transmission means for transmitting information on the conversion candidates obtained as a result of the search to the electronic apparatus.

11. A recording medium having a program according to claim 6 or 10 recorded therein.

12. An information processing apparatus comprising:
a transmission unit configured to transmit information on an input character to an information managing apparatus along with identification information identifying a process associated with a screen on which the character is input, the information being transmitted as a request for conversion of the input character;
a reception unit configured to receive information concerning candidates of words into which the input character can be converted, transmitted by the information managing apparatus in response to the request for conversion thus transmitted;
a display control unit configured to control display of a list of conversion candidates for the input character included in the received information; and
a selection accepting unit configured to accept the selection of a result of conversion of the input character from the displayed list of conversion candidates.

13. An information processing apparatus comprising:
a reception unit configured to receive a request for conversion transmitted from an electronic apparatus connected to the information processing apparatus, the conversion request including information on a character input at the electronic apparatus and identification information identifying a process associated with a screen on which the character is input;
an identifying unit configured to identify predetermined dictionary information among plural types of dictionary information stored in advance based on the identification information included in the received conversion request;
a search unit configured to search for candidates of words into which the character included in the conversion request can be converted using the identified dictionary information; and
a transmission unit configured to transmit information on the conversion candidates obtained as a result of the search to the electronic apparatus.
